(19) United States
(12) Patent Application Publication
(10) Pub. No.: US 2026/0178857 A1
(43) Pub. Date: Jun. 25, 2026

(54) HYBRID RFID-TAG

(71) Applicant: UNIVERSITÄT DUISBURG-ESSEN, Essen (DE)

(72) Inventors: Maher Khaliel AHMED, Duisburg (DE); Thomas KAISER, Duisburg (DE)

(21) Appl. No.: 19/425,182

(22) Filed: Dec. 18, 2025

(30) Foreign Application Priority Data
Dec. 20, 2024 (DE) 10 2024 212 242.4

(51) Int. Cl. G06K 7/10

(52) U.S. Cl. CPC G06K 7/10089

(57) ABSTRACT

The invention relates to an identification method having improved spatial resolution, comprising at least one reading device and at least one tag, wherein the at least one tag is coded by means of a plurality of notches, and wherein under appropriate excitation the at least one tag supplies both a linear response and a non-linear response, the method comprising the steps of: [symbol]
identifying whether one or more tags are located at a location, [symbol]
identifying which of the tags is located at the location.

The invention further relates to a system for the method according to the invention, comprising a reading device and at least one tag, wherein the reading device is configured to emit high-frequency radiation in a first frequency band in order to excite one or more tags, wherein the reading device is configured to vary the emitted radio-frequency radiation, and to receive radiation from at least one tag, and to determine a forward transmission parameter and/or an input reflection parameter.

### CROSS-REFERENCE TO RELATED APPLICATION

This application claims the benefit of German Patent Application No. 10 2024 212 242.4 filed Dec. 20, 2024, the entire disclosure of which is incorporated herein by reference in its entirety.

### TECHNICAL FIELD

The invention relates to an identification method having improved spatial resolution.

### BACKGROUND

Chipless radio frequency identification (RFID) was introduced in the early 2000s as a special type of passive RFID system in which the tag does not contain a chip and the ID is thus encoded in the physical structure of the tag. The coding can apply in the frequency domain, in the time domain, in the spatial domain, or in the hybrid domain. The tag primarily returns the coded ID when it is queried with the corresponding electromagnetic (EM) wave of the reader.

Based on the domain of the coding, the backscattered wave can be in the form of resonance peaks or notches for frequency-coded (FC) tags, multiple echoes of the incident wave for time-coded (TC) tags, or an image for spatially-coded (SC) tags. Each of these domains has its own challenges due to the lack of electronic components on the tag.

Therefore, chipless RFID tags are not able to meet the requirements of modern identification applications, including high data capacity in combination with coverage, reliable operation, size, cost, etc. The use of such tags on lossy dielectric and metallic objects also remains problematic.

In general, FC tags are the most common because they typically offer the highest coding capacity, a smaller size, and lower reader device complexity. The data is coded by controlling the presence/absence of resonance at a known frequency position, because one bit corresponds to a resonator. Given the current state of the art in the development of tags and reader devices and their limitations, overcoming the challenges is not a simple task, due to the limitations imposed by physical and design complexity.

In general, environmental interference effects and self-interference are the biggest challenges in detecting FC chipless RFID tags in a real-world environment. These reflections are much stronger than the backscatter from the tag and mask the desired tag signal even at short tag intervals below 30 cm, even with cross-polarized tags.

In addition to noise and multi-path reception, the received signal is mainly affected by interference and clutter reflections.

Accordingly, it is necessary to measure the interference and clutter reflections without the presence of the tag in order to detect the tag response. In general, the antenna mismatch, coupling (crosstalk) between the two antennas and the presence of objects in the environment would have to be subtracted. However, the subtraction method only works for one tag in a static environment. The subtraction method therefore fails when detecting multiple tags and in variable environments.

Other solutions for mitigating interference reflections are the implementation of retrodirectivity on the tag side. An example of this is known from the article “Design and analysis of chipless RFID tags based on retro-radiators” by the authors H. Li, B. Wang, M. Wu, J. Zhu, and C. Zhou, published in IEEE Access, Vol. 7, pages 148208-148217, 2019. However, a disadvantage of such solutions is the very limited coding capacity as well as an unwieldy tag size.

Depolarization has been discussed as a solution to attenuating clutter reflections. Such solutions are known, for example, from the articles “Single-layer, flexible, and depolarizing chipless RFID tags” by the authors A. Ramos, Z. Ali, A. Vena, M. Garbati, and E. Perret, published in IEEE Access, vol. 8, pages 72929-72941, 2020 as well as in the article “Clutter effect investigation on co-polarized chipless RFID tags and mitigation using cross-polarized tags, analytical model, simulation, and measurement” by the authors J. Alam, M. Khaliel, F. Zheng, K. Solbach, and T. Kaiser, published in Sensors, vol. 23, no. 17, 2023. However, the antennas of the reading device also have channel depolarization in addition to the direct cross-polarized coupling.

There are also approaches (see “Design [of] an adaptive electronically beamsteering reflectarray antenna for RFID systems” by the authors K. Hasan, M. Khaliel, M. El-Hadidy, and T. Kaiser, published in 2015 IEEE International Symposium on Antennas and Propagation & USNC/URSI National Radio Science Meeting, pages 2157-2158, 2015) to spatially minimizing clutter reflections using another antenna with an improved reflector array. However, this solution cannot be implemented for reading true chipless RFID tags, resulting in a limited quantitative analysis of the overall system performance improvement.

The article “Optimal angle in bistatic measurement for chipless tag detection improvement” by the authors R. de Amorim Junior, R. Siragusa, N. Barbot, and E. Perret, published in IEEE Transactions on Antennas and Propagation, vol. 70, no. 12, pages 12221-12236, 2022, describes an isolation between the response of the chipless tag and the marked object. The methodology uses a bistatic reading configuration in which the angle of the receiving antenna varies the direction to extract the tag ID and maximize the co-polarization response. However, the method is complex in practice and the backscattering of the radar backscatter cross-section (RCS) is significantly degraded.

Time gating is a simple and effective approach to isolating clutter reflections, in which a time window can be applied directly after the first strong peak, by virtue of the quasi-optical mode of the tag mode up to the last known resonance time (a few dozen nanoseconds). This approach is shown, for example, in the article “Robustness Improvement for chipless RFID reading using polarization separation” by the authors F. Requena, N. Barbot, D. Kadour, and E. Perret, published in IEEE Transactions on Microwave Theory and Techniques, vol. 71, no. 7, pages 3173-3188, 2023. However, in order to isolate the label from the environment effectively, either the location of the tag must be known or the location of the reader device and the label are permanently connected to each other.

From the article “Scalar method for reading of chipless RFID tags based on limited ground plane backed dipole resonator array” by the authors J. Kracek, M. Svanda, and K. Hoffmann, published in IEEE Transactions on Microwave Theory and Techniques, vol. 67, no. 11, pages 4547-4558, 2019, a measurement method for reducing the interference is known; the main disadvantage of the method being that a set of three precise vector measurements of the coefficients is required and therefore the method can only be used in an unchanged environment.

To facilitate the detection of chipless tags without calibration, the backscattered response should be either time-variant or nonlinear. However, to enable the linear time variance property, the selected object would have to move periodically, which is impractical. On the other hand, the non-linearity could be achieved by integrating a non-linear element.

Against this background, one object of the invention is to offer a simple and inexpensive solution.

### BRIEF SUMMARY

The object is achieved by a method according to claim 1 and a system according to claim 5. Further advantageous embodiments are the subject matter of the dependent claims, the description and the figures.

### BRIEF DESCRIPTION OF THE DRAWINGS

Hereafter, the invention is explained in more detail with reference to the drawings. These show:

FIG. 1 a schematic illustration of an aspect of an exemplary linear tag according to the invention with an exemplary 5 notches,

FIG. 2 a schematic illustration of a further aspect of an exemplary linear tag according to the invention with a harmonic transponder,

FIG. 3 an equivalent circuit diagram of an exemplary harmonic transponder according to the invention,

FIG. 4 an exemplary common embodiment of an exemplary linear tag according to the invention according to FIGS. 1 and 2,

FIG. 5a-d measured harmonic responses of four different tags according to embodiments of the invention,

FIG. 6a-d measured linear code responses of the four different tags according to embodiments of the invention,

FIG. 7 an exemplary system representation, and

FIG. 8 an exemplary flowchart according to embodiments of the invention.

### DETAILED DESCRIPTION

Hereafter, the invention is explained in more detail with reference to the figures. It should be noted that various aspects are described, which can each be used individually or in combination. This means that any aspect can be used with different embodiments of the invention, unless explicitly presented as a pure alternative.

Furthermore, for the sake of simplicity, only one entity is normally referred to in the following. However, unless explicitly stated, the invention may also comprise more than one of the entities concerned. In this respect, the use of the words “one”, “a” and “an” is to be understood only as an indication that in a simple embodiment at least one entity is used.

Where the following contains a description of methods, the individual steps of a method can be arranged and/or combined in any order, unless otherwise explicitly indicated by the context. Furthermore, the methods can be combined with each other, unless otherwise expressly indicated.

Specifications with numerical values are generally not to be understood as exact values, but also include a tolerance of +/−1% up to +/−10%.

Reference to standards or specifications shall be construed as reference to standards or specifications applicable at the time of filing and/or, where a priority is claimed, at the time of the priority application. This does not, however, imply any general exclusion of applicability to subsequent or superseding standards or specifications.

With reference to the figures, embodiments of the invention are explained below.

The invention relates in particular to an identification method having improved spatial resolution comprising at least one reading device L and at least one tag T1, . . . in an RF-ID-based system. The at least one tag T1 . . . or the tags T1 . . . . TN are designed as chipless devices.

The at least one tag T1 . . . /the multiple tags T1 . . . . TN is/are coded using a plurality of notches.

The at least one tag T1 . . . /the multiple tags T1 . . . . TN, under appropriate excitation by a reading device L, supply both a linear response in a first frequency band and a non-linear response in a second frequency band which is different from the first frequency band.

The method comprises, for example, the step of identifying 100, by excitation by radio frequency, whether one or more tags T1 . . . are located at a location.

Furthermore, the method comprises the step of identifying 200, by excitation by means of radio frequency, which of the tags is located at the location.

The steps 100 and 200 can be performed simultaneously or in any order.

Optionally, it can be provided that in step 300 it is checked, given a detected number of tags, whether all tags have been identified. If this is not the case, the method can be restarted. Without limiting the generality of the invention, modifications may also be provided.

In other words, the present invention presents a novel hybrid radio concept for a passive radio frequency identification radio tag (RFID tag for short), which combines the advantages of harmonic and frequency-coded (FC) chipless RFID technologies.

In particular, a non-linear (harmonic) tag is used to attenuate the ambient noise sources and enable long-range multi-tag detection, while a linear FC-chipless RFID tag concept is used to increase the coding capacity.

In addition, with an exemplary size of 5 cm×5 cm the wireless tag is compact and therefore practical for operation in the low GHz band. Within this size, for example, a harmonic 1-bit code and 4 information bits of linear codes can be coded simultaneously. The efficient harmonic coding is enabled by a novel design of a dual-band patch antenna with differential feed, which can be tuned to two harmonic frequencies simultaneously and can be matched to a Schottky diode at multiple fundamental frequencies.

As an example, 4 different harmonic tags with four different codes are considered in the exemplary embodiments in order to show how it is possible to detect multiple markings simultaneously.

Within the scope of the invention, a chipless frequency coding by (linear) dipoles can be enabled, which can be optimized for a maximum radar cross-section, narrow and deep resonances at each of the coded bits.

For example, for verification purposes, the inventors have implemented the invention in a compact size with various linear and harmonic codes, which initially operate in the frequency range from 2 GHz to 6 GHz, but can generally also be scaled up to (sub-) millimetre waves. In the metrological verification, although both linear and harmonic codes are successfully detected in a realistic environment, the detection range achieved is up to 1.4 m and 2.6 m respectively for the linear and harmonic codes, with an equivalent isotropic radiation power of 7 dBm. In addition, the multi-tag detection was successfully measured.

The tag according to the invention may comprise a chipless RFID resonator, which is designed, for example, as a λ/4 short-circuited or λ/2 open dipole. The open λ/2 dipole provides a 3 dB higher RCS (Radar Cross Section), which is why this configuration is preferred for use as a coding element.

In principle, the radiative efficiency of the half-wavelength dipole is highest when the dipole arms are straight; however, for some applications with size limitations, the dipole arms may have a meandering shape or may be provided with inductive or capacitive loads to reduce the tag geometry. Accordingly, the backscatter RCS and the resonance bandwidth can be reduced.

However, such “convoluted” embodiments often have a detrimental effect on the range of detection.

It follows from this that each coding element should have as narrow and deep a resonance bandwidth as possible in addition to the desired high value of the RCS.

These key properties can be achieved by using a straight dipole placed over a metal plate (base surface) of finite size. The use of straight dipoles with base surfaces as coding elements therefore results in a lower bandwidth than that without dipoles, a higher RCS value and a higher insensitivity to matter. In addition, the encoding mechanism is easy to manipulate, with the information bit being coded by the presence or absence of the encoding element.

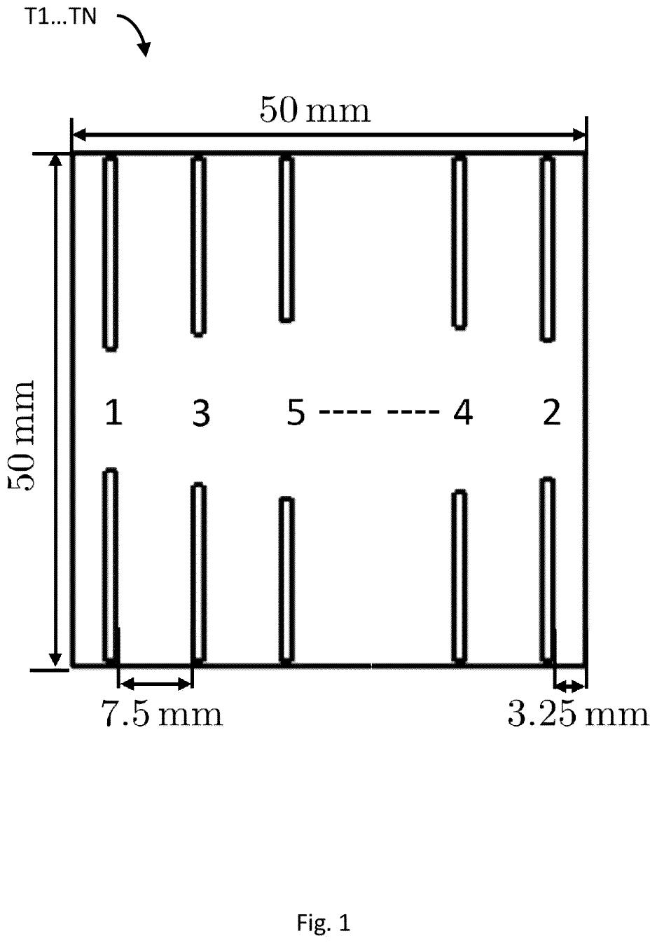

As an example, such an embodiment is shown in FIG. 1. Different dipoles are arranged on a circuit board. The dipoles can be seen as symmetrically arranged electrically conductive strips. The strips have a different longitudinal extension according to the wavelength. Each of the dipoles preferably provides a different resonant frequency/wavelength. FIG. 1 shows, e.g., 5 different dipoles with correspondingly different resonant frequencies/wavelengths. The base surface can then be provided on a further layer of the circuit board. Without limiting generality, such a structure can be produced on a printed circuit board in a variety of ways. For example, the structure can be created by selective application of a conductive material to a carrier, as well as the selective removal from a surface (e.g. by a (wet) chemical process (e.g, etching), or mechanically (e.g. milling, laser removal)) or otherwise. Likewise, the carrier does not have to be a circuit board, but can also be any suitable (insulating) carrier material.

The dipole resonance frequency can be calculated as in equation 1

$${f}_{r} = \frac{c}{2 ( {L}_{d} + Δ {L}_{d} ) \sqrt{{ϵ}_{eff}}} ,$$

where L_{d} is the dipole length and ΔL_{d} the length expansion due to stray fields or discontinuities, which is a function of the dipole width (w) and the substrate height (h). The narrower the dipole width, the narrower and shallower the resonance bandwidth for the low-loss substrates with low permittivity.

On the other hand, an increase in the dipole width results in a larger base surface.

In addition, the height of the substrate has a considerable influence on the notch width and depth, and it is inversely proportional to the resonance bandwidth.

In experiments, RO4350B with a height of 1.52 mm was selected as the substrate material. The invention is not limited to this configuration, however.

The notch depth of the designed dipole array tag achieved in the experiment is in the range of 2-3 dB.

It has been shown that the dipole spacing affects the depth of the notch and the notch depth and frequency detuning in the coding of the information bits.

In order to overcome the low notch depth, the distance between the dipoles can be optimized. An exemplary minimum distance is 7.5 mm, as shown in FIG. 1.

Advantageously, peripheral dipoles—in FIG. 1, the first dipole (indicated by 1) and the second dipole (indicated by 2)—are, for example, 3.25 mm from the substrate edge.

To further deepen the notch, two (or more) dipole elements may be provided for each coding element, wherein the notch increases by 3 dB for each additional dipole of the same length.

The linear coding part, by way of example, has five dipoles in 5×5 cm² for coding 5 bits in the frequency range from 4.5 GHz to 5.5 GHz.

The spectral capacity, defined as the number of bits that can be inserted in a given bandwidth, can be specified as 12. The space between the fourth and the fifth dipole may be provided for the harmonic transponder, as shown below.

In order to minimize the detuning during the coding, dipoles can be arranged such that the odd bit numbers are placed on the one (here left) side of the substrate and the even bit numbers on the other (here right) side, as shown in FIG. 1. The five coding notches have a selected spectral spacing of 200 MHz.

To enable error detection, the five coding notches represent 3 bits with a single parity check. Accordingly, eight code words with even weighting can be generated.

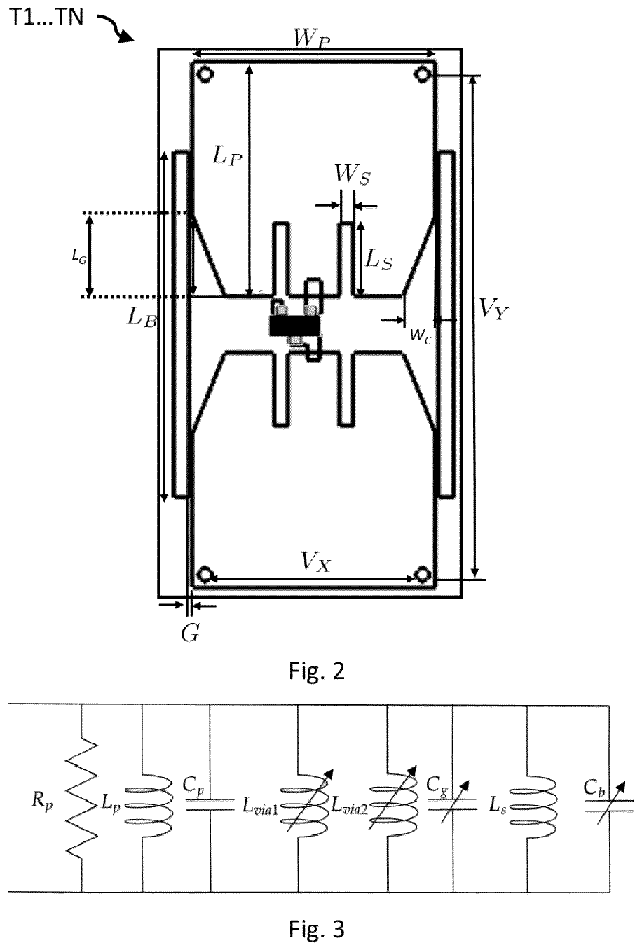

On the other hand, the TAG (T1 . . . . TN) according to the invention also comprises a harmonic transponder, which will be explained below in connection with FIG. 2.

It should be noted that harmonic transponders can also be used for tracking small objects, such as insects, in high-noise environments where the mass is a major problem. Such harmonic transponders can also be used in other applications, such as locating avalanche victims and detecting pedestrians carrying such a transponder on their bodies.

The harmonic transponder essentially has two antennas which, conjugated to a nonlinear element at (harmonically) spaced frequencies, are matched. In passive harmonic transponders, the nonlinear element is usually a Schottky diode with a low threshold voltage and operated at zero bias. Therefore, an induction loop is required to maintain a DC current path. The typical reading distance of passive harmonic transponders is between 1 m and 5 m.

The antennas are usually also dipoles. However, other antenna types are not excluded.

The inventive tag design shown in the invention has a particularly small base surface.

An exemplary transponder according to the invention has a single dual-band patch antenna, in the case of differential feed a two-band patch antenna, which gives the transponder a compact size, for example 20 mm×34 mm.

The antenna can be designed for independent tuning of the matching conditions to the nonlinear element at two (harmonically) spaced frequencies, so that good return loss and accordingly low diode conversion can be easily achieved.

At the same time, the detuning of the linear FC-chipless RFID tag integration can be taken into account, e.g. by the introduction of two charging rods which are coupled to the main radiation surface.

The two charging rods can be used to better tune the second (harmonic) resonance frequency. In addition, these two charging rods can reduce the interference between linear and harmonic transponders.

As an example, a harmonic transponder at a first frequency of 2.05 GHZ, respectively a second frequency of 4.1 GHZ, can be dimensioned as follows:

| | | |
|---|---|---|
| W_{P} | 15 | mm |
| L_{P} | 14.5 | mm |
| W_{G} | 2.15 | mm |
| L_{G} | 5.15 | mm |
| V | 12.6 | mm |
| W_{S} | 0.86 | mm |
| L_{S} | 4.5 | mm |
| L_{B} | 21.3 | mm |
| G | 0.21 | mm |
| V_{X} | 13.4 | mm |
| V_{Y} | 30.9 | mm |

The antenna structure can have a patch size of 20 mm×34 mm. A complete tag according to the invention can then have a base surface area of 50 mm×50 mm.

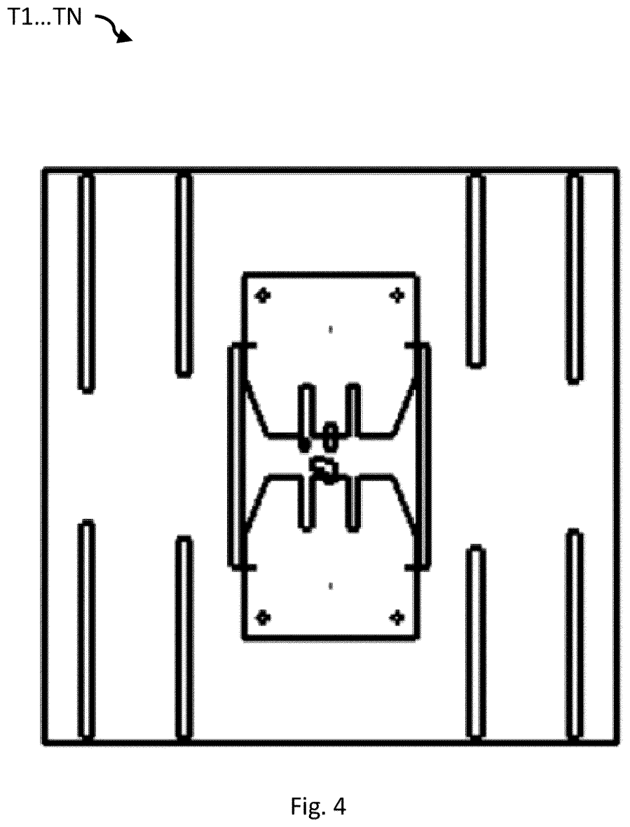

To increase the electrical length and shift the resonance frequencies into lower bands, four pairs of vias (typical radius 0.4 mm) can be added at the outer edge of the patch so that the two patches are electrically connected together. Furthermore, two charging rods can be added symmetrically to the antenna structure in order to freely adjust the resonance frequency of the second (harmonic) resonance frequency by means of the inner slots, as shown in FIG. 4.

Double plane symmetry allows the differential feed and allows a symmetrical radiation diagram.

The design according to the invention offers multiple degrees of freedom to tune the complex input impedance of the antenna, e.g. the dimensions of the patch, the dimensions of the charging rods and their distance from the patch, the number of paired vias and their spacings, the dimensions of the inner slots and finally the distance between the two patches, as shown in FIG. 3.

For tuning the input impedance at two harmonically spaced frequencies, in particular the charging rods, the gap dimensions and the distances between the vias can be used.

In this case, the tuning at the fundamental frequency can be achieved, e.g., by tuning the distances between the vias V_{X} or V_{Y} or by tuning the length L_{G} or the width W_{G} of the feed gap.

The reconfiguration of the corresponding second (harmonic) frequency band is possible by tuning the charging length L_{B}, and thus an easily reconfigurable harmonic transponder can be achieved.

The parameters of the driven circuit are explained in FIG. 4. The value of Cg is controlled by the length and width of the feed gap, which determines the fundamental resonance frequency. The value of C_{b} is determined by the dimensions of the charging rod, which determines the second (harmonic) resonance frequency.

It is obvious that a reduction in the distances between the vias either V_{X} or V_{Y} can be used to reduce the corresponding inductance L_{VIA} and thus shift the resonance frequency to higher values.

Similarly, increasing the gap length L_{G} or W_{G} can cause the corresponding capacitance Cg to decrease or the resonance frequency to shift to higher values.

On the other hand, shortening the charging rod length reduces the corresponding capacitance C_{b} and thus shifts the second (harmonic) frequency to higher values.

In the tuning method shown, the patch length L_{P} and the width W_{P} can remain constant.

To investigate the performance of the proposed harmonic transponder, the inventors simulated four different prototypes, which were later integrated with four linear tags.

An HSMS-2850 diode was used as a non-linear element, where the impedance is determined by the barrier layer capacitance, the series resistance and the parasitic values.

An exemplary tag according to the invention, which has both a linear part (according to FIG. 1) and a non-linear part (according to FIG. 2), is shown in FIG. 4. The “non-linear” part is clearly visible in the centre.

As an example, four different linear codes were generated—11000, 11110 and 11101 (where a 1 corresponds to a notch at the corresponding frequency)—to be integrated with the four different harmonic transponders.

It may be advisable here to adjust the specified geometric parameters slightly to obtain the resonance frequency for the linear and harmonic codes.

The complete structure is shown in FIG. 4 (linear code 11110, harmonic code tag3F or tag3H), wherein the harmonic transponder is held in the centre to obtain the symmetry of the pattern in both planes.

The coding capacity can be increased by repeating linear combinations for each harmonic tag.

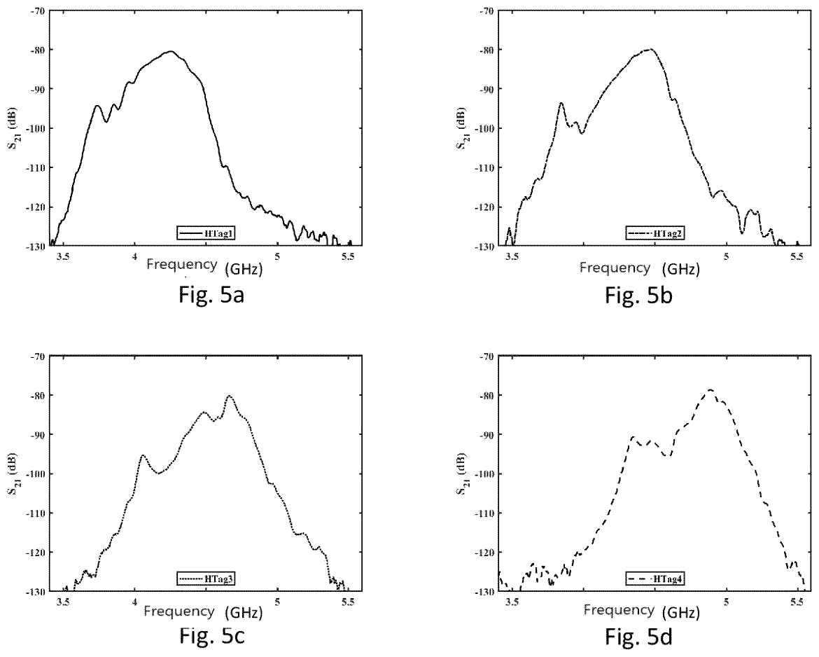

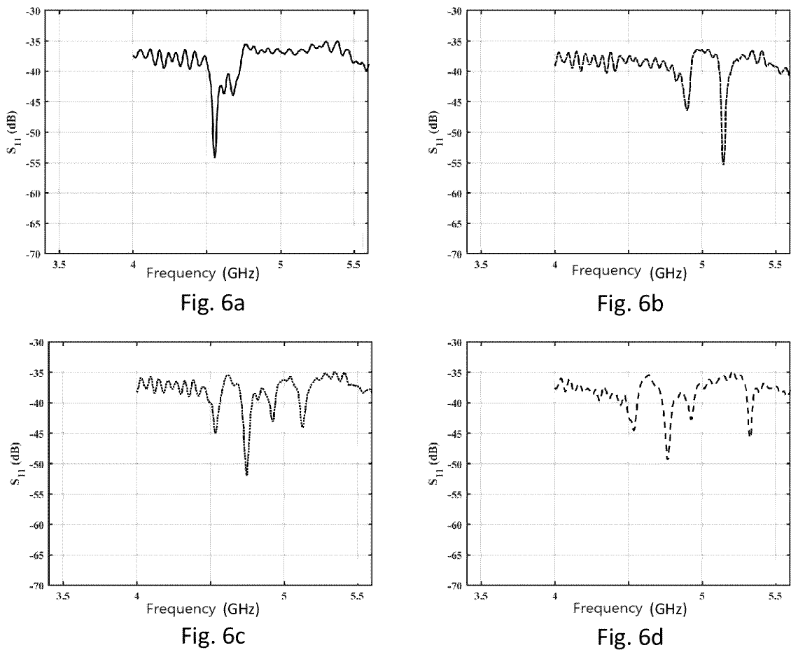

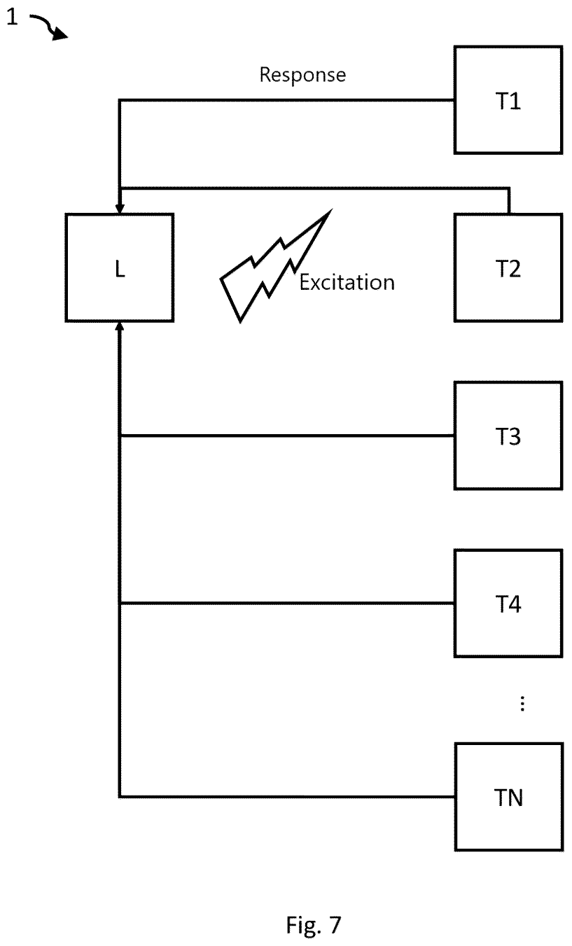

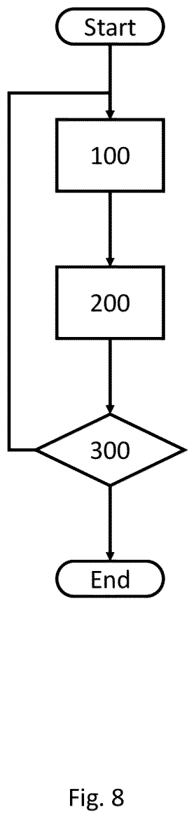

FIGS. 6a-6d show the linear codes of 4 different tags, while FIGS. 5a-5d each show the harmonic response of the different tags at a distance of 35 cm. The individual tags can be clearly distinguished.

In an identification method according to the invention, it may be provided in one embodiment that the number of tags at a location is identified by analysis of the forward transmission parameter.

In further embodiments according to the invention, a tag can be identified by analysis of a linear code of the input reflection parameter.

According to a further embodiment of the invention, the at least one reading device L can evaluate the recorded response in the first frequency band and in the second frequency band together. For example, for a determined number of tags it is possible to check whether all tags have been identified. It is also possible to check whether the number of identified tags corresponds to the number of expected tags. If no correspondence is found at all, this can be seen as an indication of a mis-detection, so that the method can be carried out again with all or only part of the steps.

According to a further embodiment of the invention, a system 1 for the methods presented is provided.

The system 1 comprises at least one reading device L and at least one tag T1, . . . . TN. The reading device L is configured to emit high-frequency radiation in a first frequency band to excite one or more tags T1 . . . . The reading device L is further configured to vary the high-frequency radiation emitted.

The reading device L is further configured to receive radiation in both a first frequency band and in a second frequency band, which is different from the first frequency band, from the at least one tag T1, . . . . The reading device L is further configured to determine a forward transmission parameter or an input reflection parameter with respect to the at least one tag T1, . . . .

This makes it possible to determine not only the number, but also the identity of the tags.

According to one embodiment of the system according to the invention, the at least one tag T1, . . . is linear and has a linear coding by means of suitably designed dipoles.

In a further embodiment of the system according to the invention, the at least one tag T1, . . . is produced by means of printing technology. Both conductor tracks and semiconductors, such as the non-linear element, can be produced in printing technology.

Furthermore, in a further embodiment of the system according to the invention it is provided that at least 3 bits are provided for the coding.

In yet another embodiment of the system according to the invention, frequencies from the gigahertz range, in particular from the range greater than 2 GHZ, are used for the high excitation frequency. On the receiving side of the reading device L, frequencies from the gigahertz range, in particular from the range greater than 2 GHZ, are also used.

In particular, it may be provided in embodiments that the second frequency band represents a harmonic of the first frequency band, in particular the first harmonic of the first frequency band.

1. An identification method having improved spatial resolution, comprising at least one reading device (L) and at least one tag (T1, . . . ) in an RF-ID-based system, wherein the at least one tag (T1 . . . ) has a chipless design, wherein the at least one tag (T1 . . . ) is coded by means of a plurality of notches, and wherein under appropriate excitation by a reading device (L) the at least one tag (T1 . . . ) supplies both a linear response in a first frequency band and a non-linear response in a second frequency band, which is different from the first frequency band, the method comprising the steps of: [symbol]
identifying (100), by excitation by radio frequency, whether one or more tags (T1 . . . ) are located at a location, [symbol]
identifying (200), by excitation by radio frequency, which of the tags is located at the location.

2. The identification method according to claim 1, wherein the number of tags at one location is identified by analysis of the forward transmission parameter.

3. The identification method according to claim 1, wherein a tag is identified by analysis of a linear code of the input reflection parameter.

4. The identification method according to claim 1, wherein the at least one reading device evaluates the recorded response in the first frequency band and in the second frequency band together.

5. A system for the method according to claim 1, comprising a reading device and at least one tag, wherein the reading device is configured to emit high-frequency radiation in a first frequency band in order to excite one or more tags, wherein the reading device is further configured to vary the emitted radio-frequency radiation, wherein the reading device is further configured to receive radiation from the at least one tag in both a first frequency band and in a second frequency band, which is different from the first frequency band, wherein the reading device is further configured to determine a forward transmission parameter and/or an input reflection parameter with respect to the at least one tag.

6. The system according to claim 5, wherein the at least one tag is linear and has a linear coding by means of suitably designed dipoles.

7. The system according to claim 5, wherein the at least one tag is produced by means of printing technology.

8. The system according to claim 5, wherein at least 3 bits are provided for the coding.

9. The system according to claim 5, wherein frequencies from the gigahertz range are used for the high frequency.

10. The system according to claim 5, wherein the second frequency band represents a harmonic of the first frequency band.

11. The system according to claim 5, wherein the second frequency band represents the first harmonic of the first frequency band.
